(19) United States
(12) Patent Application Publication
(10) Pub. No.: US 2009/0008618 A1
(43) Pub. Date: Jan. 8, 2009

(54) Gate Post Assembly

(76) Inventors: Mark John Milligan, Queensland (AU); Glen David Battese, Queensland (AU)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/664,718

(22) PCT Filed: Oct. 5, 2005
(86) PCT No.: PCT/AU2005/001529

§ 371 Date: Feb. 19, 2008

(30) Foreign Application Priority Data
Oct. 5, 2004 (AU) 2004216675

(51) Int. Cl. E06B 11/02

(52) U.S. Cl. 256/1

(57) ABSTRACT

A gate post assembly including at least one gate post (10), each gate post having a sidewall which is at least partially arcuate, at least one opening (11) for receiving therein a fence barrier member and at least one planar portion (12) formed in the perimeter thereof adapted to receive gate mounting and/or securing fittings, the planar portion provided parallel to the fence barrier member which extends into the opening of the post and at least on spacing member (20), shaped to be fitted into and secured in the at least one opening in the gate post to locate the fence barrier member.

### FIELD OF THE INVENTION

The present invention relates to gate post assemblies and in particular to a gate post assembly for mounting hinges thereon about which a gate can swing and a gate post assembly for mounting a latching system thereon to secure a gate against opening.

### BACKGROUND ART

Gate post assemblies for fences are known in the art for a variety of uses, one of which is pool fencing. Whilst the invention of the present application is not limited to application in pool fencing, a discussion of pool fencing post assemblies is most useful in an appreciation of the prior art base in relation to the present invention as the gate assemblies in the pool fences always have a hinge arrangement on a first side of the gate and a latching mechanism on the opposed side of the gate.

Pool safety fencing has proven, over the past thirty years, to be the most practical and effective barrier against accidental pool drowning. Pool fence can be constructed of many different materials and many different arrangements of fencing barriers, one of which, at least partially transparent, polyester or glass mounted on aluminum or fiberglass support poles, has recently become particularly popular. The fence barrier is located into aluminium or plastic sleeves installed about the pool surrounds. The bottom border of the fence material may be flush or separated by a small distance from the surface of the ground or pool surround so as to prevent a child from pushing under.

As an example, various legislation and standards are in place in most jurisdictions which deal with the requirements of a complying swimming pool fence. For a swimming pool constructed on or after 1 Oct. 2003, a complying pool fence built in Queensland, Australia:
Must be at least 1.2 m in height and constructed so that it inhibits access by young children to the pool area;
Cannot have horizontal members close than 900 mm;
Cannot have vertical members greater than 1000 nm apart or any gap under the fence greater than 100 mm; and
Must be constructed around swimming pools that are not fully enclosed by the walls of a building.

Most pool safety fences include a gate having hinges allowing the gate to swing open and closed on one side and a latching mechanism o the opposite side of the gate. The most common and popular latching system used in Australia is a magnetic latch on sale under the brand Magnalatch®. The most common form is the vertical pull locking latch. This latch has a top-mounted knob which is pulled upwardly to release the strike from the latching mechanism. The knob is mounted at or above the top of the gate and is therefore at a height of at least approximately 1.2 m from the ground, making it extremely difficult for small children to operate the latch without the assistance of an adult. The latch can also be locked to prevent operation. The latch is a magnetic latching mechanism and therefore has little mechanical resistance to closure. The latch and strike are both manufactured with planar portions to facilitate attachment of the latch and the latch illustrated in FIG. 1 is mounted to a rectangular gate and gate post assembly.

Where the latch is to be mounted to a circular gate and gate post assembly, an adaptor kit is provided to adapt the standard planar mounting portions of the latch and strike to facilitate the attachment to a circular post and gate. The adaptor kit is illustrated in FIG. 2. Most importantly in the kit is provided a portion with an arcuate opening on a first side and a planar portion on the reverse side. The arcuate opening attaches to the circular post or gate and the planar side facilitates the attachment of the standard planar portions of the latch and strike assembly.

The adaptor kit is quite expensive and therefore many alternatives have been used ranging from a simple box section attached, generally by welding or similar) directly to the circular gate and post to much more elaborate and complex multi-part systems. These all require additional components and usually extra work to attach the systems prior to mounting the latch and strike thereto. They are untidy and often are less secure than the attachments provided by the adaptor kits or the standard planar portions attached to rectangular gates and posts.

It would be a significant advance if a post assembly were provided that enabled the secure and tidy attachment of a latch with planar attachment portions to a circular cross-section post, without requiring more work for the fence and gate builder or installer.

It will be clearly understood that, if a prior art publication is referred to herein, this reference does not constitute an admission that the publication forms part of the common general knowledge in the art in Australia or in any other country.

### SUMMARY OF THE INVENTION

The present invention is directed to a gate post assembly, which may at least partially overcome at least one of the abovementioned disadvantages or provide the consumer with a useful or commercial choice.

In one form, the invention resides in a gate post assembly, particularly for transparent glass or plastic fence barriers, the assembly including at least one gate post, each gate post having at least one opening for receiving therein a fence barrier member and at least one planar portion formed in the perimeter adapted to receive gate mounting and/or securing fittings.

The assembly includes at least one gate post. There will preferably be two gate posts in each assembly, one gate post located on each side of the gate allowing entry and egress to the area bounded by the fence or barrier in which the gate is located. The respective posts of the gate post assembly are suitably inverted with respect to each other. This inversion of one gate post with respect to the other orients the planar portion of both gate posts on the same side of the fence.

A lower portion of the gate posts will typically be securely located in or to the ground surface. Each gate post is generally hollow with an external periphery which is at least partially shaped in cross-section to correspond to the shape of a conventional post such as circular. One or more rib members typically extend into or towards the centre of the post.

Each gate post includes at least one opening therein. Preferably, the opening is a channel, which typically extends over the full height of the post. The channel typically includes a pair of spaced apart side walls joined by a base wall. The side walls preferably converge toward each other as they extend towards the centre of the post. The channel typically receives an edge of a planar fence panel, and as suggested is particularly adapted to receive a planar glass or similar fence panel.

Each side wall of the channel is typically provided with transversely extending locking portions which suitably extend partially into the channel. The locking portions are preferably provided in pairs of portions on opposite side walls. There may be at least one pair and preferably at least two pairs. The pairs of locking portions are spaced over the length of the side walls.

There are also a pair of locating extensions adjacent the outer end of each of the side walls. The locating extensions are provided to assist with the location of a spacing member in the channel.

Each gate post also includes at least one planar portion thereon. The planar portion, as with the channel, preferably extends over the entire height of the post. The planar portion is typically provided parallel to the fence barrier which extends into the channel of the post for a straight fence. It may be positioned at an angle as desired for the shape of a particular fence.

The portion is provided to give a flat surface on the gate post to facilitate the attachment of the gate fittings, including the hinges and latching assembly thereon. The planar portion is preferably associated with at least one shaped opening. There will typically be more than one and the openings are provided to engage correspondingly shaped portions provided on a cover member. The openings are provided over the length of the post.

The gate post assembly may further include at least one spacing member. The spacing member is suitably shaped to be fitted into and be secured in the channel. The spacing member is adapted to form a flush fit with the perimeter of the post. When fitted, the spacing member may give the appearance of an uninterrupted perimeter to the post.

The spacing member may be a substantially U-shaped member in cross-section. The member may have an arcuate base wall from which extends a pair of spaced apart, planar side walls, the side walls each having a free end. The side walls are suitably spaced from the ends of the arcuate base wall to provide shoulder portions on the arcuate base wall.

Each side wall preferably has a wedge-shaped extension located at or closely spaced from the free end of the side wall. The wedge-shaped extensions may act as locking tabs, engaging the locking portions of the side walls of the channel to maintain the spacing member in position in the channel. Alternatively, the side walls may lack the wedge-shaped extensions and the spacing member may be fixed in position using fasteners extending through the base wall of the member.

The spacing member will typically be snap fitting into the channel but may also be slid into position from the upper or lower end of the post. The shoulder portions on the arcuate base portion may abut the locating extensions in the channel to prevent the spacing member being pressed too far into the channel and maintaining the arcuate base portion flush with the perimeter of the post.

There may further be at least one arm member extending from the base portion in the same direction as the side walls, from between the side walls. The arm member may be provided to support the planar fence panel. There will normally be two arm members provided to spread the load.

There may generally be one spacing member provided at the lower end of the gate post to space the bottom of the planar fence panel from the ground surface. The planar fence panel is then generally located on the spacing member in the channel. A second spacing member is then provided at the upper end of the gate post to secure the fence panel in position.

There may be at least one cover member provided. The cover member is adapted to be secured relative to the planar portion of the gate post. It is shaped to be fitted to and be secured about the planar portion. The cover member is adapted to form a flush fit with the perimeter of the post. When fitted, the cover member may give the appearance of an uninterrupted perimeter to the post.

The cover member may have a cutaway portion to allow a hinge to open and close through the cover member when in position. The cover member is suitably provided with correspondingly shaped portions to engage the openings associated with the planar portion. The cover member will typically be snap fitting into the channel but may also be slid into position from the upper or lower end of the post.

All portions and members of the post assembly are preferably extruded and manufactured of metal or plastic but preferably of aluminium. Each gate post may be provided with an attachment portion to enable attachment of a post cap at the upper extremity to prevent loss or removal of the cover and spacing members from the planar portion and channel respectively, or to secure the members in position. The attachment portion will typically be an opening to engage a threaded member such as a screw which may extend through the post cap. The post cap may preferably have rounded edges to minimise or cover the possibly sharp edges of the upper extremity of the gate post.

### BRIEF DESCRIPTION OF THE DRAWINGS

Various embodiments of the invention will be described with reference to the following drawings, in which:

FIG. 1 is a perspective view of a conventional Magnalock®.

FIG. 2 is an explanatory diagram of a conventional round post adapter kit for a Magnalock®.

FIG. 3 is a cross-sectional view of a gate post according to a preferred embodiment of the present invention.

FIG. 4 is a cross-sectional view of a gate post according to a preferred embodiment of the present invention showing typically dimensions.

FIG. 5 is a cross-sectional view of a gate post (in dotted lines) according to a preferred embodiment of the present invention, with the cover member shown in position.

FIG. 6 is a cross-sectional view of a cover member according to a preferred embodiment of the present invention showing typically dimensions.

FIG. 7 is a cross-sectional view of a gate post (in dotted lines) according to a preferred embodiment of the present invention, with the spacing member shown in position.

FIG. 8 is a cross-sectional view of a spacing member according to a preferred embodiment of the present invention showing typically dimensions.

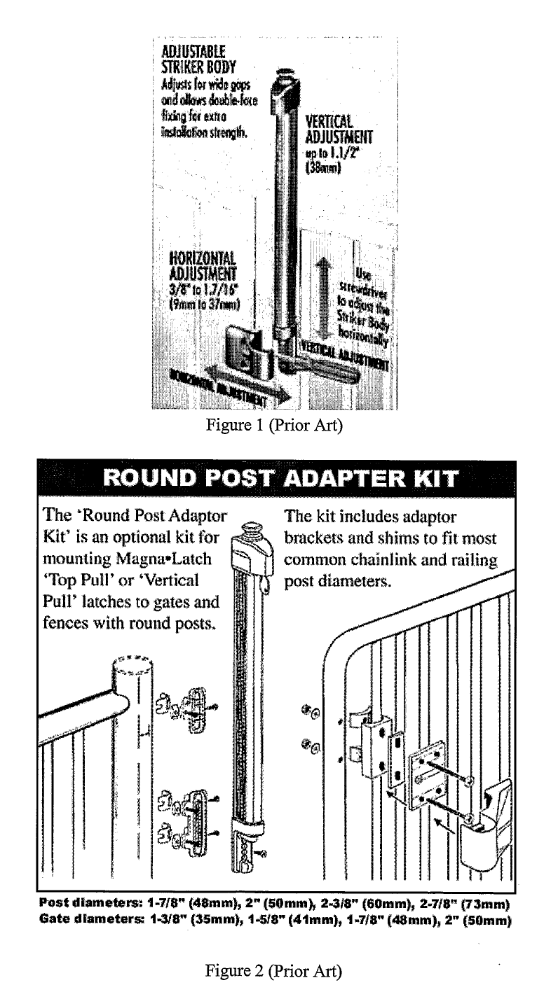

### DETAILED DESCRIPTION OF THE PREFERRED EMBODIMENT

According to a preferred embodiment of the present invention, a gate post assembly is provided. The assembly of the present invention is particularly adapted for transparent glass or plastic planar panel fence barriers.

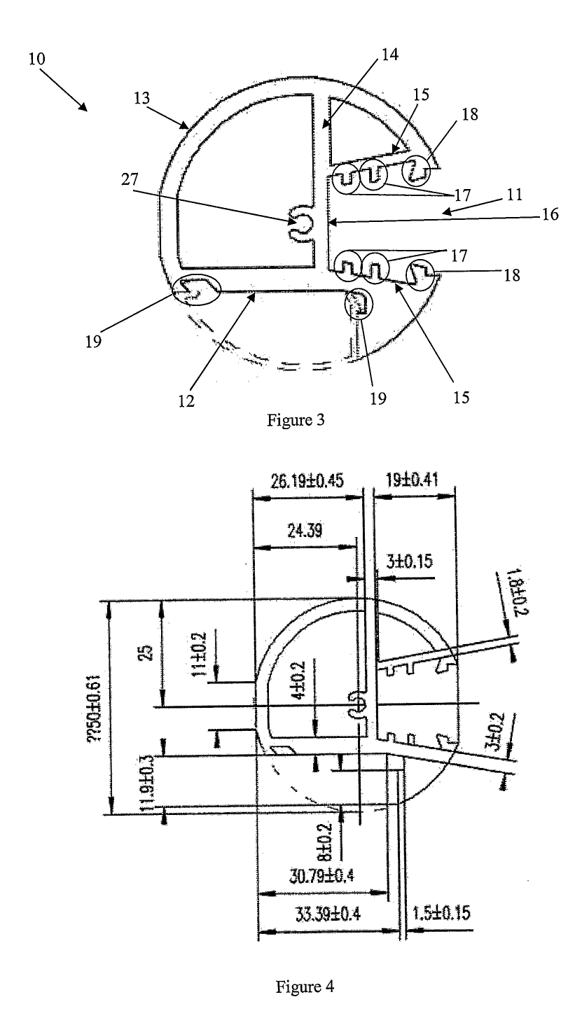

The assembly of the preferred embodiment includes at least one gate post 10 as illustrated in cross-section in FIG. 3. Each gate post 10 has an opening 11 for receiving therein a fence barrier member. Each post also has a planar portion 12 thereon adapted to receive gate mounting and/or latch fittings.

There will generally be two gate posts 10 in each assembly, one gate post 10 located on each side of the gate allowing entry and egress to the area bounded by the fence or barrier in which the gate is located. The respective posts 10 of the gate post assembly are inverted with respect to each other. This inversion of one gate post 10 with respect to the other orients the planar portion of both gate posts 10 on the same side of the fence.

A lower portion of the gate posts 10 will be securely located in or to the ground surface. Each gate post 10 is hollow with an external periphery 13 and at least partially circular in cross-section. One or more rib members 14 extend into or towards the centre of the post 10.

Each gate post 10 has an channel-shaped opening 11 therein. The channel 11 extends over the full height of the post 10. The channel 11 includes a pair of spaced apart side walls 15 joined by a base wall 16. The side walls 15 converge toward each other as they extend towards the centre of the post 10. The channel 11 is provided to receive an edge of a planar fence panel (not shown), and as suggested is particularly adapted to receive a planar glass or similar fence panel.

Each side wall 15 of the channel 11 is provided with transversely extending locking portions 17 which extend partially into the channel 11. The locking portions 17 are provided in pairs, one locking portion 17 on opposite side walls 15. There are at least two pairs of locking portions 17 in the preferred embodiment illustrated in the Figures. The pairs of locking portions 17 are spaced over the length of the side walls 15.

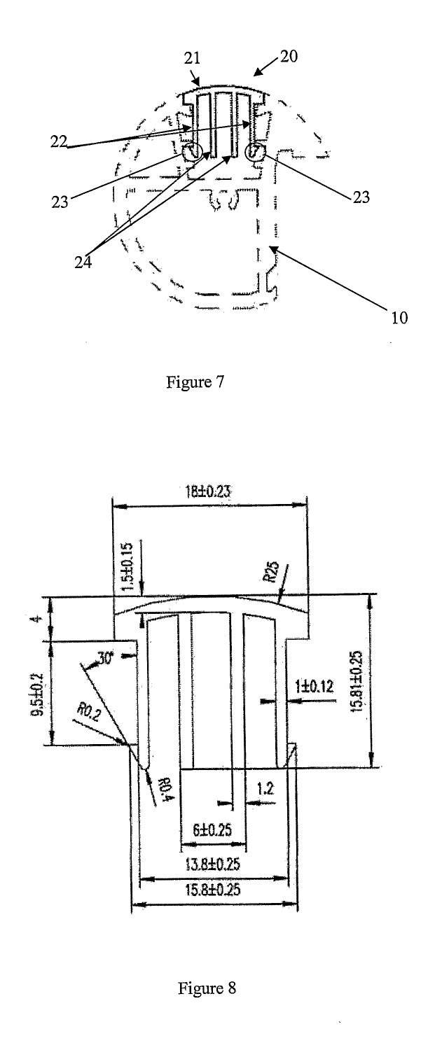

There are also a pair of locating extensions 18 adjacent the outer end of each of the side walls 15. The locating extensions 18 are provided to assist with the location of a spacing member (illustrated in FIGS. 7 and 8) in the channel 11.

Each gate post 10 also includes a planar portion 12 thereon to facilitate easy attachment of the gate hinges and latch fittings thereto. The planar portion 12, as with the channel 11, extends over the entire height of the post 10. The planar portion 12 is provided parallel to the fence barrier panel which extends into the channel 11 of the post 10 for a straight fence. It may be positioned at an angle as desired for the shape of a particular fence.

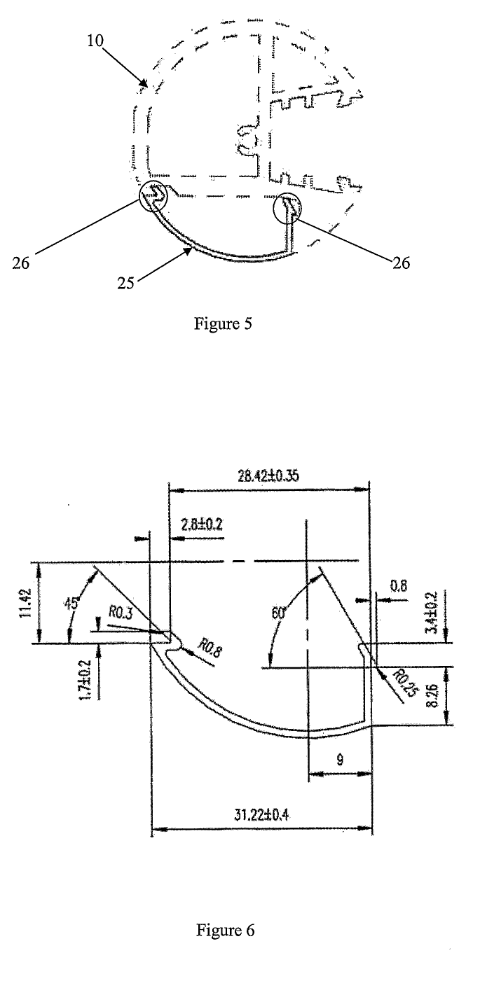

The planar portion 12 is associated with shaped openings 19 to facilitate attachment of a cover member (illustrated in FIGS. 5 and 6) thereto. The shaped openings 19 are provided to engage correspondingly shaped portions provided on a cover member. The shaped openings 19 are provided over the length of the post 10.

The gate post assembly further includes at least one spacing member 20 as illustrated in FIGS. 7 and 8. The spacing member 20 is shaped to be fitted into and be secured in the channel 11. The spacing member 20 is adapted to form a flush fit with the perimeter 13 of the post 10. When fitted, the spacing member 20 gives the appearance of an uninterrupted perimeter 13 to the post 10.

The spacing member 20 is a substantially U-shaped member in cross-section. The member 20 has an arcuate base wall 21 from which extends a pair of spaced apart, planar side walls 22, the side walls 23 each having a free end. The side walls 22 are spaced from the ends of the arcuate base wall 22 to provide shoulder portions on the arcuate base wall 22.

Each side wall 21 has a wedge-shaped extension 23 located at or closely spaced from the free end of the side wall 21. The wedge-shaped extensions 23 act as locking tabs, engaging the locking portions 17 of the side walls 15 of the channel 11 to maintain the spacing member 20 in position in the channel 11.

The spacing member 20 will be snap fitting into the channel 11 but may also be slid into position from the upper or lower end of the post 10. The shoulder portions on the arcuate base wall 21 abut the locating extensions 18 in the channel 11 to prevent the spacing member 20 being pressed too far into the channel 11 and maintaining the arcuate base wall 21 flush with the perimeter 13 of the post 10.

There is also at least one arm member 24 extending from the base wall 21 in the same direction as the side walls 22, from between the side walls 22. The arm member 24 provides support the planar fence panel. There are two arm members 24 provided to spread the load.

In use, there will generally be one spacing member 20 provided at the lower end of the gate post 10 to space the bottom of the planar fence panel from the ground surface. The planar fence panel is then generally located on the spacing member 20 in the channel 11. A second spacing 20 is then provided at the upper end of the gate post 10 to secure the fence panel in position.

There will further be at least one cover member 25 provided. The cover member 25 is adapted to be secured relative to the planar portion 12 of the gate post 10. It is shaped to be fitted to and be secured about the planar portion 12. The cover member 25 is adapted to form a flush fit with the perimeter 13 of the post 10. When fitted, the cover member 25 and the spacing member 20 give the appearance of an uninterrupted perimeter 13 to the post 10.

The cover member 25 will have a cutaway portion (not shown) to allow a hinge to open and close through the cover member 25 when in position. The cover member 25 is provided with correspondingly shaped portions 26 to engage the shaped openings 19 associated with the planar portion 12. The cover member 25 will also be snap fitting into the channel 11 but may also be slid into position from the upper or lower end of the post 10.

All portions and members of the preferred embodiment of the post assembly are extruded and manufactured of metal or plastic but preferably of aluminium. Each gate post 10 is provided with an attachment portion 27 to enable attachment of a post cap (not shown) at the upper extremity of the post 10 to prevent loss or removal of the cover and spacing members from the planar portion and channel respectively, or to secure the members in position.

In the present specification and claims (if any), the word “comprising” and its derivatives including “comprises” and “comprise” include each of the stated integers but does not exclude the inclusion of one or more further integers.

Reference throughout this specification to “one embodiment” or “an embodiment” means that a particular feature, structure, or characteristic described in connection with the embodiment is included in at least one embodiment of the present invention. Thus, the appearance of the phrases “in one embodiment” or “in an embodiment” in various places throughout this specification are not necessarily all referring to the same embodiment. Furthermore, the particular features, structures, or characteristics may be combined in any suitable manner in one or more combinations.

What is claimed is:

1. A gate post assembly, particularly for transparent glass or plastic fence barriers, the assembly including at least one gate post, each gate post having a sidewall which is at least partially arcuate, at least one opening for receiving therein a fence barrier member and at least one planar potion formed in the perimeter thereof adapted to receive gate mounting and/or securing fittings, the planar portion provided parallel to the fence barrier member which extends into the opening of the post and at least one spacing member, shaped to be fitted into and be secured in the at least one opening in the gate post to locate the fence barrier member.

2. A gate post assembly according to claim 1 wherein there are two gate posts in the assembly, one gate post located on each side of a gate allowing entry and egress to an area bounded by a fence or barrier in which the gate is located.

3. A gate post assembly according to claim 2 wherein the respective posts of the gate post assembly are inverted with respect to each other to orient the planar portion of both gate posts on the same side of the fence.

4. A gate post assembly according to claim 1 wherein the opening is a channel including a pair of spaced apart side walls joined by a base wall, the channel adapted to receive an edge of a planar fence panel.

5. A gate post assembly according to claim 4 wherein each side wall of the channel is provided with at least one transversely extending locking portion which suitably extends at least partially into the at least one opening.

6. A gate post assembly according to claim 1 wherein the planar portion is associated with at least one shaped opening to engage correspondingly shaped portions provided on a cover member.

7. A gate post assembly according to claim 1 wherein the spacing member is a substantially U-shaped member in cross-section, having an arcuate base wall from which extends a pair of spaced apart, planar side walls, the side walls each having a free end.

8. A gate post assembly according to claim 7 wherein each side wall has a wedge-shaped extension located at or closely spaced from the free end of the side wall to act as locking tabs to maintain the spacing member in position in the channel.

9. A gate post assembly according to claim 7 further including at least one arm member extending from the base portion in the same direction as the side walls, from between the side walls.

10. A gate post assembly according to claim 1, further comprising at least one cover member adapted to be secured relative to the planar portion of the gate post to form a flush fit with the perimeter of the post.
